(19) United States
(12) Patent Application Publication
(10) Pub. No.: US 2016/0350752 A1
(43) Pub. Date: Dec. 1, 2016

(54) Anti-Fraud Credit &Debit Card Computer Program

(71) Applicant: Cesar Edwardo Turbides, Central Islip, NY (US)

(72) Inventor: Cesar Edwardo Turbides, Central Islip, NY (US)

(21) Appl. No.: 14/613,118

(22) Filed: May 26, 2015

(51) Int. Cl. G06Q 20/40; G06Q 20/26; G06Q 20/24

(52) U.S. Cl. CPC G06Q 20/40; G06Q 20/24; G06Q 20/26

(57) ABSTRACT

This is a computer program and accompanying app for use with cellular telephones, mobile devices, and computers is without customer specific front-end code as this will be unique to each customer (i.e. credit card issuing company). This computer program/app marries a credit or debit card to a unique signal or MAC address on your cellular phone, mobile device, or computer for the purpose of fraud protection via customer transaction authentication and approval. This is accomplished through a chain reaction of real time requests for authorization of purchase and their respective responses passing from a retailer to card provider to card holder and back using software installed onto the associated chain of hardware in a process similar to “digital handshake” with various options of security.

### BACKGROUND

This computer program/app for mobile devices pertains to the unauthorized and fraudulent use of credit and debit cards. The financial institutions that issue these cards along with their insurance companies and individual consumers collectively lose billions annually to credit and debit card theft and unauthorized use.

Presently, unauthorized use of credit and debit cards is a simple feat for criminals to accomplish and is, in most cases, not even detected until well after the fact. Similarly other more complicated forms of credit and debit card fraud also go undetected and unabated until it's too late.

Standard methods of detection of fraud or unauthorized use have been limited to programs that develop spending trends or patterns and only when a purchase does not fit those trends or patterns is the card issuer alerted whereby they, in turn, contact the card holder for verification of the purchase.

Current technology has advanced to the point where instantaneous verification of transactions through a secondary secure channel is possible and this is one issue that this program addresses. This program also attempts to ameliorate, if not completely eliminate, through prevention, the cost associated with investigating and prosecuting these cases of theft and fraud.

### BRIEF SUMMARY OF INVENTION

This computer program/app simply directs a security process including the routing of both a request for verification/authorization of a purchase and the cardholder's response. Through the use of a series of real time requests and authorizations between a cardholder and a retailer this computer program attempts to address the financial losses incurred by theft and fraud of debit and credit cards with an added layer of security. These requests for verification/authorization and their respective responses are sent via secure transmissions through preexisting communication and data transmission infrastructures to and from the financial institution where the controlling software is located. This software, which includes a database that “marries” a cardholder's account information to a list of the cardholder's cellular phone(s), computer(s), or other mobile device(s), is responsible for the routing of the requests and authorizations.

It's through an application or “app” on the cardholder's cellular phone, computer, or other mobile device that the requests are received and either the granting or denial of authorization is sent back to the retailer through the financial institution. Added security can be had through password protection of the authorizations/requests sent through the “app”.

Within seconds the retailer will have received verification and authorization of the transaction from the cardholder through a secondary secure means routed through the cardholder's financial institution thereby helping to eliminate fraudulent and unauthorized use.

### DETAILED DESCRIPTION

This computer program and accompanying app is used to “marry” or correlate a user's cellular phone, computer, or other mobile device to his or her credit or debit card through the use of a series of encrypted requests and responses for the purpose of increased security from credit or debit card theft, fraud, and unauthorized use.

The process begins when a cardholder uses their credit or debit card to make a purchase. Once the card is either swiped at the point of sale or the card number is used to make an online purchase and a funds availability check has been initiated an additional query, herein after referred to as a “Request to Authorize Purchase” or “Request”, is sent from the retailer to the card holder's financial institution as listed by the information encoded on the cards magnetic strip. This request “piggybacks” with or is sent in the same data transmission as the funds availability checks and contains identifying information of both the retailer and the transaction in question. Once the financial institution has received this request, the controlling software that is installed on the financial institution's server immediately logs the incoming request, assigns a system number, and then accesses a secure database to determine the destination of the request. The incoming request contains information pertinent to the transaction including but not limited to: the date and time, retailers name, location, transaction type, amount, card holder's name, card holder's account number, etc. Using this information, the controlling software identifies the cardholder and cross-references its database. The database, then correlates or “marries” the card holder's account information with a predetermined list of MAC addresses assigned to the individuals cellular phone, computer, or other mobile device. The controlling software determines the destination of the request by ascertaining the first available device on the MAC address list by sending a ping to device number one. If device number one fails to respond, has been turned off, or is otherwise unavailable, the program proceeds to device number two and repeats the process. The program will continue down the list of devices until it either establishes contact with a device or reaches the end of the list. If the software cannot establish contact with any off the devices listed, it will then send a response to the retailer indicating that approval was not acquired and deny the transaction.

Assuming the program establishes contact with a device it will forward the request for authorization to an “app” that is already installed on the cardholder's device, initiate a timer, and await a response. The “app” has the option of using password protection to open or view the requests. The cardholder either approves or denies the request that is then automatically returned to the financial institution as an “Authorized Response”. This authorized response contains the system number originally assigned to the request in order to identify it and it's final destination. If the request is not answered within the specified timeframe, the system software will send a second request. If the second request is not answered, a third and final request is sent to the cardholder. If this final request remains unanswered an automated denial response is sent to the retailer indicating the cardholder has not given approval of the transaction.

When the card holder responds to the request with an approval and the financial institution receives the returning response the system software will first verify authenticity of the response then identify the sender of the original request by cross-referencing the system number and system log. The software will then forward the response to the retailer who either finalizes or denies the transaction based on the response.

1. A unique system of secondary authentication for credit or debit card transactions, said system including a controlling program, a database, a mobile app, and a series of requests and responses interconnected via preexisting data transmission lines.
